(19) United States
(12) Patent Application Publication
(10) Pub. No.: US 2015/0355107 A1
(43) Pub. Date: Dec. 10, 2015

(54) TETHERED SENSING SYSTEM FOR PIPELINES

(71) Applicant: PURE TECHNOLOGIES LTD., Calgary (CA)

(72) Inventor: Peter O. PAULSON, Calgary (CA)

(21) Appl. No.: 14/758,103

(22) PCT Filed: Dec. 30, 2013
(86) PCT No.: PCT/CA2013/051013

§ 371 Date: Jun. 26, 2015

Related U.S. Application Data
(60) Provisional application No. 61/746,848, filed on Dec. 28, 2012.
(60) Provisional application No. 61/770,648, filed on Feb. 28, 2013.

(51) Int. Cl. G01N 21/954; G01D 5/353

(52) U.S. Cl. CPC G01N 21/954; G01D 5/35354; G01N 2021/9546

(57) ABSTRACT

The invention relates to a novel tethered sensing system having a tethered sensing unit which is connected to a surface location through a tether with no electrical cabling whatsoever, and which includes at least one optical fibre for control and data-collecting. The sensing unit can be retracted easily, and can be moved easily back and forth in the pipeline when it is desired to study areas of particular interest of the pipeline wall.

### CROSS REFERENCE TO RELATED APPLICATIONS

This application claims priority to U.S. Application Nos. 61/746,848 filed Dec. 28, 2012 and 61/770,648 filed Feb. 28, 2013, the contents of which are incorporated by reference herein in their entirety.

### FIELD OF THE INVENTION

This invention relates to a tethered sensing system for use in pipelines.

### BACKGROUND

It is known to inspect the interior of pipelines with flowing fluid in them by inserting a tethered sensing unit into such pipelines. The tethered sensing unit is provided with a drogue which is pulled through the pipeline by the flow of the fluid in the pipeline. This urges the sensing unit to extend into the pipeline to the full distance permitted by the tether. An above ground winch pays out additional tether as desired to permit the sensing unit to pass through the pipeline at a desired speed, until all of the tether has been paid out.

Tethered systems of this type are shown in Bond U.S. Pat. No. 6,889,703 and Day U.S. Pat. No. 5,084,764.

While tethered systems, particularly of the type shown in the Bond patent, have found use in inspection of fluid filled pipes, the cables must be bulky in order to accommodate the necessary electrical wires to power the sensors in the sensing unit and to receive data from them. The bulk of the cable limits the length of cable that can be deployed, and also requires a large winding drum to store the cable. Further, when it is desired to retract the cable from the pipeline, considerable force is needed to overcome the pulling force of the drogue and the friction of the fluid in the pipeline on the cable and sensing unit. This is especially the case if the pipeline has bends in it, and the cable must be pulled back around those bends. In order to reduce the likelihood of the cable breaking in such circumstances, further bulky reinforcement strands must be included in the cable, thus adding to its diameter and limiting the amount of cable that can be stored on a single reel.

### BRIEF DESCRIPTION OF THE INVENTION

The invention relates to a novel tethered sensing unit which has a tether with no electrical cabling whatsoever, and which includes at least one optical fibre for control and data-collecting. The sensing unit can be retracted easily, and can be moved easily back and forth in the pipeline when it is desired to study areas of particular interest of the pipeline wall.

### DETAILED DESCRIPTION OF THE INVENTION

The invention will be described by first describing the inventive tether, then the inventive sensing unit, then a mechanism for inserting the tether and sensing unit into a pipeline and controlling them thereafter.

### The Tether

The tether comprises within it one or more optical fibres (single mode or multimode) for data transmission. If the sensing unit is powered by light gleaning, as described below, or laser light is required for a lamp, one or more additional optical fibres, preferably multimode, are present . These may be carried in the same or separate fibre optic cables. In addition, there is optionally one or more sensing fibre optic cables. A shielded sensing cable with one or more Bragg gratings along it is preferred. An OTDR sensor or a combined OTDR-Sagnac sensor as described in Paulson U.S. Pat. No. 7,564,540 can also be used, in which case the sensing portions of such sensor can extend substantially along the entire length of the tether which is intended to be inserted into the pipeline, or along only a portion of that length, for example the portion which will be farthest inserted into the pipeline when the tether is fully extended.

No metallic wires or other metallic power conductors are present in the tether.

The fibre optic cables are embedded in a material which has good tensile strength, for example the polymers sold under the trademarks Kevlar™ (a high tensile strength para-aramid) or Spectra™ (an ultra high molecular weight polyethylene). This is in turn sheathed in an abrasion-resistant layer, which can be for example thermoplastic polyurethane or other known polymer material. An outer sheath, which is inert to the fluids expected to be in the pipeline with which the tether is used, then covers the polyurethane sheath. This can for example be a fluoropolymer, such as polytetrafluoroethylene marketed under the trademark Teflon™. Preferably, the outer sheath is transparent, so that markings on the inner sheath can be read through it. Such markings can indicate for example the overall density of the tether or other construction details about it, or indicate the tether length at convenient intervals such as one metre. The finished tether cable is preferred to be round in cross-section, and may be for example 5-10 mm in diameter, preferably 6-8 mm.

As will be seen, deploying and retracting the tethered sensing unit of this invention does not require as large a tensile strength as is necessary in prior art tethered systems. Typically, the retracting force needed, depending on the distance the tether has been deployed through the pipeline, is from 10 pound force to 40 pound-force (4.54 kilogram-force to 18.14 kilogram-force). Therefore, a tether having a breaking strength of as little as 400 pound-force (181.43 kilogram-force) is suitable. This is less than the force usually needed to retract tethered systems of the type shown in Bond U.S. Pat. No. 6,889,703, and far less than the breaking strength that tethers of such systems must have. A smaller drogue can also be used. For example, in a pipeline in which water is flowing at 2 ft. per second (0.61 metres per second), a drogue with a diameter of 8″ (20.3 cm) is sufficient to deploy the sensing unit, and retrieval required a force of only about 30 pounds force (13.62 Kilogram-force when the sensors were 1200 ft. (365.7 m) along the pipe. The electrical cable arrangement used in the type of arrangement shown by Bond typically requires a 16 inch (40.6 cm) diameter drogue and several hundred pounds of force to deploy it, and even more to retrieve it. The actual choice of drogue size depends on the pipe diameter and the velocity of the flowing liquid, as well as the number of turns and undulations in the course of the pipe.

According to the invention the tether is preferred to be approximately of neutral density for the fluid in which it is to be deployed. Many tethered units are used to inspect potable water pipes, so the density of such tethers should be approximately the density of water at the expected temperature at which inspection is to take place. If the tethered unit is to be used to inspect some other fluid, such as a petroleum product, the density should approximate that of the petroleum product to be inspected. The density can be controlled when the tether is made by choosing a suitable density material from the Kevlar™ or Spectra™ products which are commercially available to give the desired final density.

Therefore, tethers to be used in inspecting pipelines carrying potable water are preferred to have a density of from about 950 Kg/m³to about 1020 Kg/m³. For use in pipelines inspecting petroleum products, the preferred density is lower, and preferably ranges from for example 740 to 950 Kg/m³, depending on the product.

Tethers of 4-5 kilometers in length can be used according to this invention, so that the sensing unit can be deployed up to 4 or 5 kilometers from its point of insertion. In pipelines which have few bends, longer tethers are also expected to be useable.

### The Sensing Unit

The sensing unit of this invention is preferably of approximately neutral density with respect to the fluid in which it is to be used, to reduce drag. Therefore, as discussed with respect to the tether, overall density of the sensing unit is chosen with regard to the fluid in which the sensing unit is designed to be used . Therefore, for use in inspecting pipelines carrying potable water, it is preferred to have a sensing unit with an overall density of from about 950 Kg/m³to about 1020 Kg/m³. For use in pipelines inspecting petroleum products, the preferred overall density is lower, and may range from for example 740 to 950 Kg/m³, depending on the petroleum product.

The densities of the different components of the sensing unit are of course different. The desired overall density can be reached by distributing the components along the sensing unit, and providing when necessary air cavities or weights in the sensing unit to adjust the density.

The sensing unit is preferably divided into modules joined by flexible connectors. Many access points to a pipeline are at a 90° angle to the axis of the pipeline, so the sensing unit must negotiate a 90° bend while being placed axially in the pipeline at the commencement of the inspection if such an access point is used. The maximum length of the modules between flexible connectors is chosen depending on the diameter of the pipeline which is to be inspected and the angle that the access point makes with the pipeline, so that the overall sensing unit can bend sufficiently to enter the pipeline. The use of short modules also permits the sensing unit to negotiate sharp bends within the pipeline and to pass through some valves. Typically, modules are 10-12 inches (25.4 cm -30.5 cm) in length, although they can be longer or shorter depending on the application. Their diameter is typically from about 2 inches to 4 inches (5.1 cm to 10.2 cm). The flexible connectors can vary in length, and may be used to extend the overall length of the sensing unit to space components from one another. For example, a typical sensing unit can have an overall length of 45-96 inches (114.2 cm to 243.8 cm).

Suitably, the flexible connectors are made of a different material than the modules, and some have air spaces within them. For example, the modules can be metallic and the flexible connectors can be polymeric, or polymers of different densities can be used. This retards and damps the travel of acoustic waves down the length of the sensing unit. Thus when the sensing unit has both an acoustic transmitter and one or more acoustic receivers, the receivers are placed on different modules from the transmitter, so that they receive mostly acoustic waves passing through the fluid of the pipeline, whereas the waves transmitted through the length of the sensing unit are delayed and partially dissipated while passing through intermediate flexible joints and modules of the unit.

In most cases, except where the fluid within the pipeline to be inspected is opaque , it is preferred to mount a lighting unit and a camera on the end of the sensing unit remote from the tether. This end of the sensing unit will be called the “nose”. The camera can be digital or video. Fiber optics can transmit video signals or digital signals over long distances with little loss. If a video camera is used, a converter is provided to change the video signal into analog or digital optical signals to be sent to the surface through the fiber optics of the tether. This provides high quality video, which is likely to be far better than the video transmitted over a distance of several kilometers by conventional copper wires.

One preferred embodiment uses a custom circuit board that converts the video signal to a digital bit-stream and multiplexes it with several audio (acoustic) channels and control interfaces. The controls allow adjustment of the illumination for the video camera, and control of the instruments in the sensing unit as well as continuous and high speed data transfer to the surface. A fish-eye lens is particularly useful in the inspection of the pipeline wall because it requires no pan/tilt/zoom system to provide a view of the pipe wall nearly normal to the pipe wall. This arrangement also makes better use of the illumination provided near the camera. A lens with >150 degrees of viewing angle is particularly suitable for this purpose

The lighting unit is typically a high-intensity LED lamp powered by batteries, preferably rechargeable lithium batteries. However, laser light which is light-piped through the tether can be used instead in to illuminate if desired.

Instead of using batteries, power-gleaning equipment can be used to convert light transmitted the through fibre optic fibres of the tether to generate electrical energy where it is needed, for example to operate the camera and/or the light, or to operate other electrically operated sensors. Such gleaning equipment is available from RLH Industries, Inc. 936 N. Main Street Orange Calif., 92867 USA. Such power gleaning equipment and/or batteries are used to supply electrical power to all devices within the sensing unit which require such electrical power, and will not be described individually with respect to other devices, such as for example the acoustic generator described below.

An acoustic generator is also preferably placed in the sensing unit, preferably in a module near the nose. In particular, a generator of low frequency pulses, for example 20-2000 Hz. has been found to be particularly useful. This generator can be used as a pulse generator for the location of impaired sections of pipeline wall, as disclosed in Paulson published application WO 2010/015082. The generation of acoustic pulses for this process can be carried out using a speaker housed in a leak-proof chamber. The electric pulses used to drive the speaker or other output device can be of different waveforms including sinusoid, square, and other pulse types suitable for accurate arrival time measurement. Curved surface emitters such as barrel stave emitters can conveniently produce the acoustic energy required. In most cases, a power amplifier is helpful to drive the emitter to create a sufficiently large acoustic pulse that it can be detected accurately notwithstanding the ambient noise in the pipeline. On other modules spaced from the pulse generator there can be acoustic receivers for the use of the invention shown in Paulson published application WO 2010/015082. One or more further receivers can be Bragg gratings on a shielded sensing cable forming part of the tether.

It is found that having several spaced receivers improves the quality of the data received. For use in the process of Paulson published application WO 2010/015082, the receivers should be at least one pipe diameter from the pulse generator. Thus for example, for use in a 12″ (30.5 cm) diameter pipe, receivers on other modules could be spaced 12″ (30.5 cm), 24″(61 cm), 36″(91.5 cm) and 48″(122 cm) from the pulse generator, and one or more receivers could be Bragg gratings on the tether at a more remote distance from the pulse generator.

It is found that the bandwidth available using this invention is of particular benefit in the process of Paulson published application WO 2010/015082. Sampling rates of at least 192000 samples per second collected at the acoustic receivers are beneficial for precise results in that process. This can easily be handled in the optical fibres of the invention. However, normal audio connections using copper wires such as twisted pair wires cannot provide more than about 44100 samples per second. This invention therefore improves the results obtainable from the process of Paulson published application WO 2010/015082.

The Bragg gratings and acoustic receivers can also function as hydrophones to listen for leak noises as known in the art.

Where the pipeline to be inspected is ductile or cast iron or steel, or is wire reinforced, it is useful to include in one module a magnetometer, preferably arrayed axially to the sensing unit, or such an axial magnetometer and one other orthogonal to it, or three orthogonal magnetometers. These can be used examine in more detail sections which have been indicated by the process of Paulson published application WO 2010/015082 to be impaired. An advantage of the tethered system of the invention is that the tether can be partially retracted with little effort and little risk of breakage because of the low forces needed for retraction, so that particular sections of the pipeline can be traversed several times, or the sensing unit can be positioned stationary in a particular location for careful examination with several types of sensor.

The precise location of the sensing unit can be found in several ways. The amount of tether deployed into the pipe is known from the measuring device on the tether insertion apparatus. If the pipeline has been mapped accurately, this will show the location of the sensing unit, as the flow of liquid in the pipeline acting on the drogue will keep the tether substantially fully extended.

However, not all pipelines are mapped accurately. Therefore, it is preferable to have additional means available to determine the location of the sensing unit more accurately.

One useful method is to provide on the sensing unit a sensor sensitive to low frequency electromagnetic fields. At frequencies around 20 Hz., emissions from a transmitting antenna at the surface can be detected. This is useful for tracking the position of the sensor from the surface. This is accomplished by relaying the signal from the receiver, through the fiber optic to the surface, and then via radio link to the operator of the low frequency transmitter on the surface. The operator can then move the transmitting antenna on the surface above the pipeline until the emissions are at maximum.

Another method is to use the pulse generator on the sensing unit to generate low frequency sound which can be tracked on the ground surface above the pipeline to help locate where the sensing unit is. This is similar to a tracking method disclosed in Bond U.S. Pat. No. 6,889,703.

Another, and preferred, method of locating the sensing unit precisely is to include an inertial measurement unit (IMU) in a module of the sensing unit. Suitable devices are available from Seiko Epson Corp, Sensing System Operations Division, of Nagano, Japan. They draw very little power and are sufficiently small to be included in a module. The results from such a unit can be combined with the known tether deployment length and preferably cross-checked with locating by an operator the ground surface using low frequency sound as discussed above .

Other known sensors can be placed on modules of the sensing unit to detect particular data of use in assessing a particular pipeline. For example, detectors to sense the presence of particular chemicals, or temperature sensors, can be provided.

The output of all sensors must be either stored on board the sensing unit for later download or else transmitted as light signals through an optical fibre in the tether. It is preferred to convert and transmit the signals in real time. The light signals can be either analogue or digital. Any sensor outputs which are not in suitable light signal form are transmitted (as by electrical wires passing through the modules and the flexible connectors) to a converter module where they are converted to suitable light signals for transmission along the tether.

The converter module also converts control signals from an above-ground operator which are transmitted along an optical fibre in the tether to control and operate sensors in the sensing unit when necessary.

Conveniently, the converter module is the module at the end of the sensing unit which abuts the tether.

The sensing unit is provided with one or more drogues, to propel it through the pipeline. Drogues such as those shown in Bond U.S. Pat. No. 6,889,703 and Day U.S. Pat. No. 5,084,764 can be used. It is preferred that the sensing unit of the invention be provided with a camera which faces along the axis of the pipe. If it is provided with such a camera, the drogue should have an axial hole so that the camera has an unimpeded view along the axis of the pipe. Typically, only one drogue will be used, and will be positioned close to the nose of the sensing unit, but it is known to use a second drogue spaced along the sensing unit. This may be desirable, particularly where the sensing unit is long.

The Insertion Apparatus

The tether is normally wound on a drum having sufficient space to maintain a minimum bending radius sufficiently large to minimize optical losses. The dimensions of the drum will vary depending what length of tether is to be wound on it, and the diameter of the tether. For example, a drum with an inner diameter of approximately 6″ (15.25 cm) and a length of approximately 18″ (45.7 cm) is suitable for the winding of 2000 m. of tether of 6 mm diameter. The drum assembly includes a fiber optic rotary joint to which one end of the tether is secured, a driving mechanism based on a variable speed electric drive, and a level-winding mechanism to distribute the cable evenly across the width of the drum. The driving mechanism does not need to be capable of pulling the full breaking strength of the tether. The source of the main pulling force for the tether is the winch described below. The drum is designed to be sufficiently small and light weight to be transported in a commercially available carrying case.

To insert the equipment into a pressurized pipe, the method described by Bond U.S. Pat. No. 6,889,703 is preferable with only slight modifications. The drogue and sensing unit are placed within a guide tube as shown in Bond and the guide tube guides the drogue and sensing unit (with the tether attached to it) into the pressurized pipe. As in Bond, the tether is fed into the pipe by a winch arrangement comprised of one large rotatable wheel or pulley, surrounded in part by smaller traction wheels urged against the outer diameter of the larger pulley. The purpose of this arrangement is to allow driving torque to be applied to the large pulley, and to increase the friction of the tether on the large pulley by compressing the tether between successive smaller traction wheels. The driving torque in one arrangement is provided by an electric variable speed drive which is small and silent, instead of the hydraulic winch drive used by Bond. This is possible because the smaller tether of the invention does not require as much torque as prior art arrangements.

The tether, when it comes off the winch, is passed through a sealing gland into the pressurized pipe. The tether is stiff and resistant to bending so, if care is taken to constrain the tether as it approaches the sealing gland, the friction of the tether on the winch can be used to force the tether through the sealing gland into a pressurized pipe. Combined with the relatively small diameter of the tether, sufficient force can be developed to push the cable into the gland and pressurized pipe without requiring a net towing force from the drogue. This is a very important development as the flowing fluid in the pipe need only exert a very modest force on the tether to draw the tether into the pipe. This in turn permits the use of the relatively low strength tether because the force required to withdraw the tether against the flow of the fluid is also diminished. Any one or more of the traction wheels can also include an encoder to measure the relative length of the cable as it passes over the winch, so that the length of the tether within the pipe at any time can be known.

As known in the art, if the sensing unit is to be used in a potable water pipeline, the sensing unit and tether are suitably sterilized before insertion into the pipeline, and the portions of the insertion apparatus which come into contact with the sterilized tether and sensing unit are also suitably sterile.

Cabling from the variable speed drives on the drum and on the winch, cabling from the encoder, and optical cabling from the rotary optical joint on the drum may all be connected to a controller system. The controller system contains the drive electronics, and receiver systems to accept information from the winch, the drum, the encoder, and from the fiber optic tether. The controller system may also include analogue/digital systems and digital processing devices such as a laptop computer. Displays connected to the controller are provided to the operator who utilizes the information in the use of the equipment. The replacement of some cabling by use of wireless links is advantageous in reducing the clutter of cables on the work site, so provision for wireless transfer may be made on selected equipment. The controller system and all of the other surface equipment may also be designed to be transportable in commercially available transport cases.

### DRAWINGS

The invention will be described further with respect to drawings, in which:

FIG. 1 is a perspective drawing, partially cut away, showing one embodiment of the tethered sensing unit for pipelines and its tether, together with equipment for inserting the sensing unit and its attached tether into a pipeline.

FIG. 2 is a cross-section, much magnified, of the tether, taken along lines 2-2 of FIG. 1.

### DESCRIPTION OF THE DRAWINGS

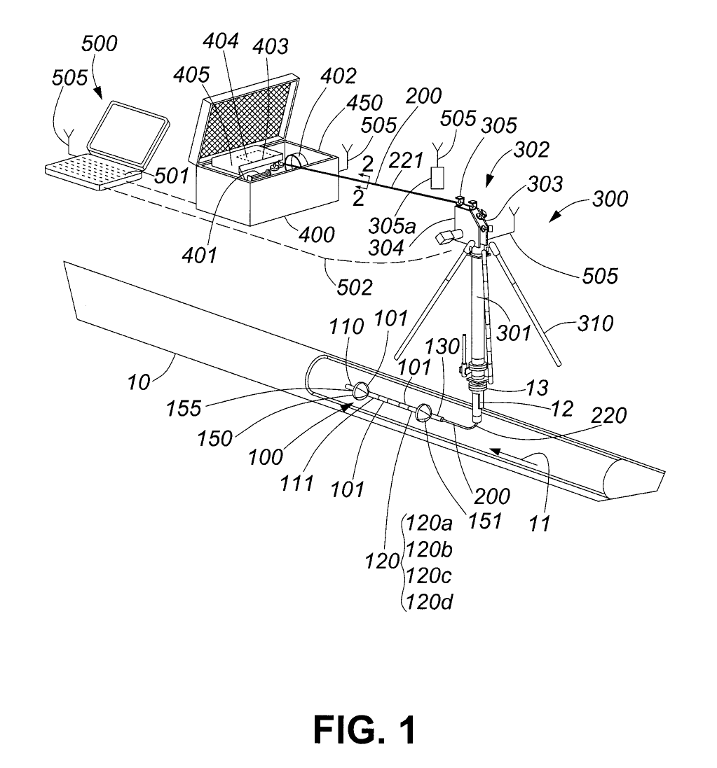

With reference to FIG. 1, a pipeline 10 is shown. The pipeline is filled with fluid (for example potable water) with the direction of flow of such fluid shown at 11. The pipeline is provided with an access port which comprises a short pipe extension 12, terminating in a valve 13. Typically, the pipeline is buried underground, and the pipe extension 12 goes upward from it a sufficient distance so that the valve 13 is accessible from ground level. In FIG. 1, the ground is not shown for clarity.

A sensing unit 100 according to the invention is shown deployed in the pipeline. This sensing unit is attached to a tether 200. This tether runs through pipeline 10 to spur pipe 12, up spur pipe 12 through valve 13 into insertion equipment generally shown at 300. The insertion equipment also governs the speed at which tether is permitted to pass into the pipeline, and withdraws the tether and sensing unit from the pipeline once the desired inspection has been completed.

The insertion equipment is similar to that described in Bond U.S. Pat. No. 6,889,703, and will be described only generally. It comprises a hydraulic cylinder 301 similar to that shown in

Bond connected in a fluid-tight way to valve 13. The hydraulic fluid storage and pump associated with the cylinder and the guide tube extending below, as described in Bond, have been omitted for clarity. The tether 200 emerges from the top of the hydraulic cylinder to pass over a winch 302, which is suitably supported on a tripod 310. The winch has a series several small wheels 303 which compress the tether against a larger powered wheel (not shown, as it is concealed behind plate 304 in the drawing) in the manner shown in Bond U.S. Pat. No. 6,889,703. The friction of such wheels against the tether holds it, and moves it as the large powered wheel is turned. In the Bond patent, the winch is described as preferably being operated by a hydraulic motor. It is found more to be convenient here to use an electric motor, as the tether of this invention is much smaller than that shown in Bond and less force is needed to move it into or out of the pipeline.

Suitably, as shown in Bond, there is a wheel 305 which engages the tether and rotates when the tether moves, to measure the length of tether passing through the insertion equipment. From this, the length of tether in the pipeline can be determined. As an alternate to using wheel 305, there can be a scanner 305a which scans marks on tether 200 representative of length.

Tether 200 then passes to a tether storage and control area 400, which is conveniently contained in a rugged portable storage box 450. Within tether storage and control area 400 is a reel 401 on which the tether is wound. An electric motor (not shown) rotates the reel to wind or unwind tether as necessary. The electric motor is controlled along with the motor for winch 302, so that the two work together and a generally constant tension is maintained between winch 302 and reel 401. Reel 401 can be provided with a level-winding mechanism (not shown) to distribute the cable across the reel as desired.

The end of cable 200 is connected to a fibre optic rotary joint which outputs data to an optical converter (shown generally as 402) which converts signals in optical form to electrical digital signals and receives laser light generated by laser 403 and control signals. There is also a head end 304 for any sensing fibres in the tether, such as fibres with one or more Bragg gratings or OTDR or OTDR-and Sagnac sensing sections. Laser 403 and head end 404 are contained, with their necessary circuitry, in a robust container 405. Means to supply electric current, such as a plug to be connected to a source of electricity, are provided, but are not illustrated for clarity.

A control unit 500, which can be for example a laptop computer, controls the operation of the system. Control unit 500 operates the motors of winch 302 and the motor controlling reel 401. It can also operate the hydraulics of cylinder 301, although such hydraulics can also be manually pumped if desired. It also receives and records the output of the sensors on sensing unit 100 as received at optical converter 402, and sends when necessary control signals to sensing unit 100 which are converted to optical signals and sent to the tether through converter 402 and the the fibre optic rotary joint. Control unit 500 can be connected by cabling to tether storage and control unit 400 and insertion unit 300 if desired, and such cabling is shown in dashed form at 501 and 502. However, to avoid unnecessary complicated cabling, it is preferred that control unit 500 be connected with other units wirelessly. This is illustrated in the drawing by antennae 505, although in practice the antennae would be internal within the units and not be visible.

The sensing unit 100 shown in FIG. 1 will now be described.

The sensing unit is comprised of modules, which are generally about 10 inches (25.4 cm) long, spaced from one another by flexible connectors 101 of variable length, usually between about 5 inches (12.7 cm) and 10 inches (25.4 cm) long.

The extreme downstream end of the unit is module 110 which contains a high intensity lighting unit, preferably directed axially downstream of the unit. The lighting unit can obtain light piped through to it by optical fibre 201a. Alternately, it can obtain power from a battery unit contained in adjacent module 111. Module 110 also contains a camera with a suitable (preferably fish-eye) lens permitting it to take digital photographs or video of the pipeline downstream of the sensing unit.

Optionally but preferably, module 110 also contains an acoustic generator, which generates sound in the 20 Hz-2000 Hz range.

Module 111 is optionally present. If it is present, it contains rechargeable lithium batteries, and is provided with a suitable watertight opening so that the batteries can be recharged when the sensing unit is retrieved from the pipeline. If present, the batteries can be used to power the camera, high intensity light and any sensors which need power. Electrical wiring passes through the modules and flexible connectors to provide power where necessary.

Module 120 is shown as a single module for mounting sensing equipment. However, depending on the amount of sensing equipment to be employed, there can be several modules 120 separated by flexible joints 101. While the items discussed below as 120a-120d are said to be present in module 120, it is understood that they can be distributed between several such modules.

Module 120 contains a hydrophone 120a. This listens for leaks in known fashion and outputs its data in the form of electrical signals that pass to module 130 described below. The hydrophone also acts as a receiver for the acoustic generator in module 110, so that such acoustic generator can be used for the practice of the pipe wall strength analysis as shown in Paulson published application 2010/015083. Bragg grating 220 also acts as a receiver for that process, as does Bragg grating 221 once it has been fed into the pipeline as the sensing unit moves downstream.

Module 120 also contains an inertial measuring system 120b, and circuitry to pass the output of such system to module 130, described below. If the sensing unit is to be used in iron or steel pipe or wire-wrapped concrete pipe, from one to three magnetometers 120c are also present. If a single magnetometer is present, it is oriented axially to the axis of the sensing unit.

Other sensing equipment 120d can be present depending on what sort of inspection of the pipe is required. This could include a side-looking camera and associated lighting, or chemical or temperature sensors.

Module 130 is typically the most upstream of the modules, and is the one to which the tether is connected. It contains a converter which converts electrical signals from sensors and video signals and the inertial measuring system to the form of light pulses so that they can be transmitted through optical fibre 201b to converter 402 and thence to control unit 300. The converter also receives control commands from control unit 500 and distributes them to sensors or other equipment within the sensing unit. For example, control commands may require the acoustic generator on module 110 to emit a sound, or may require the lighting unit on module 110 to adjust intensity.

Module 130 also contains power gleaning equipment to convert light received over fibre 201a to electrical power to power the camera, lighting unit and sensors. The power gleaning equipment may be omitted if sufficient power is available from the batteries in module 111.

Drogue 150 is provided to move the sensing unit within the pipeline, by being pushed by the flow of the pipeline fluid. Drogue 159 has a hole 155 through which module 110 protrudes, so that the camera and light have a clear view downstream of the unit. It is possible to have the drogue positioned downstream of the unit, and to have a hole in it so that the light and camera can see beyond it, but this is not preferred, as a better view is obtained when the camera and light protrude through.

Optionally, a second drogue 151 is positioned about the sensing unit upstream of drogue 150, to provide a further push to move the sensing unit down the pipeline. The second drogue should only be deployed if it can be spaced far enough from drogue 150 so that it does not create turbulence which affects the operation of drogue 150.

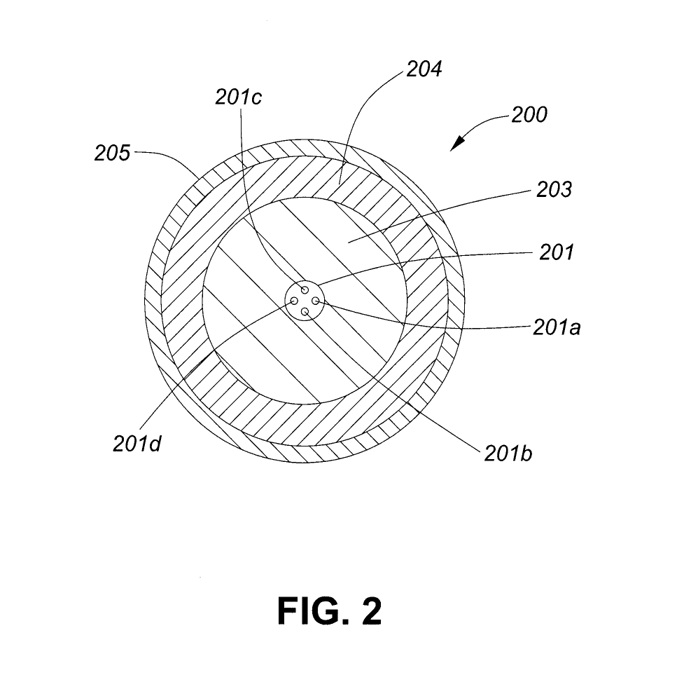

FIG. 2, which is a cross-section of the tether 200 at section lines 2-2 of FIG. 1, at greatly expanded scale, will now be described.

Tether 200 contains within it one or more optical fibres. For illustration, four such fibres are shown, contained within an optical cable 201. The cable 201 can of course contain many optical fibres, and some fibres can be separate from the cable, or there may be several fibre optic cables. Each fibre may have more than one function and there may be more than one fibre having the same function. For illustration, each of the four fibres shown is described as having a different function.

Optical fibre 201a is a multimode fibre which pipes light from laser 403 to the sensing unit 100. In the sensing unit, such light can be converted to electrical power using power gleaning equipment. Alternately, the light can be used as a light source for a lighting unit providing light for the operation of a camera.

Optical fibre 201b is a single or multimode fibre which transmits data from sensors within the sensing unit 100 to the optical reader 403, from which the data is transmitted to control unit 500 for storage and evaluation by human operator.

Optical fibre 201c is a single or multimode fibre which receives control commands from the control unit 500 which have been converted into optical signal form through the optical converter 402.

Optical fibre 201d is an optical sensor. For example, it can be a sensor having one or more Bragg gratings, which are lengths where the fibre is not shielded and is therefore receptive to external stimulation, such as acoustic or pressure waves. With reference to FIG. 1, Bragg gratings are shown at 220 and 221.

Surrounding optical cable 201 is a mass 203 of a polymer having a high tensile strength, such as Kevlar™ brand para-aramid or Spectra™ brand ultra high molecular weight polyethylene. This is in turn surrounded by an extruded coating of thermoplastic polyurethane 204 and a thin outer layer 205 of a polymer which is inert to the fluids in which the tether 200 is expected to be immersed. Preferably, this is polytetrafluoroethylene or a similar compound.

In some circumstances, it may be preferred that one or more fibres 201d be located separate from the cable 201 but within the mass 203.

It is understood that the invention has been described with reference to specific embodiments, and that non-inventive modifications to these embodiments may occur to those skilled in the art. Therefore, the protection claimed is not limited to the embodiments, but is as set out in the appended claims.

1. A tethered sensor system for use in a pipeline, comprising;
(a) a drogue
(b) a sensing unit
(c) a tether line which contains at least one optical fibre and no metallic wiring
(d) means for extending and retracting the tether line.

2. A tethered sensor system as claimed in claim 1 in which the sensing unit includes
(a) a lighting source directed to illuminate a portion of the pipeline
(b) a camera to take fixed or moving images of the portion of the pipeline illuminated by the lighting source
(c) circuitry so that such images can be transmitted by a said optical fibre through the tether to a viewing or recording station external to the pipeline.

3. A tethered sensor system as claimed in claim 1 in which the sensing unit includes an inertial measurement unit to determine changes in the location of the sensing unit , and means for sending the output of such inertial measurement unit in real time by means of a said optical fibre to a control system external to the pipeline.

4. A tethered sensor system as claimed in claim 1 in which the sensing unit includes an acoustic generator generating low frequency sounds in the range 20-2000 Hz, and means to control the generator from a station external to the pipeline through a said optical fibre in the tether .

5. A tethered sensor system as claimed in claim 1 in which the sensing unit includes an acoustic receiver, and means to receive output from said acoustic receiver at a station external to the pipeline through a said optical fibre in the tether.

6. A tethered sensor system as claimed in claim 1 in which the sensing unit includes at least one magnetometer, and means to receive output from said magnetometer at a station external to the pipeline through a said optical fibre in the tether.

7. A tethered sensor system as claimed in claim 1, in which the sensing unit includes at least one battery to provide electric power to components of such sensing system.

8. A tethered sensor system as claimed in claim 1 in which the tether transmits light through said at least one optical fibre to the sensing unit, and further comprising power gleaning apparatus to convert light received from the tether into electrical power in the sensing unit.

9. A tethered system as claimed in claim 1 in which the tether is composed of at least one fibre optic cable, strengthening material and a surrounding jacket of a polymer impervious to the fluid of the pipeline with which it is designed to be used.

10. A tethered system as claimed in claim 1 in which the tether comprises a fibre optic interferometer with at least one Bragg grating.

11. A tethered system as claimed in claim 1 in which the tether comprises an OTDR fibre interferometer.

12. A tethered system as claimed in claim 1, in which the tether is of approximately neutral density for the fluid carried by the pipeline with which is expected to be used.

13. A tethered system as claimed in claim 1, in which the tether has a density of from about 950 Kg/m3 to about 1020 Kg/m3.

14. A tethered system as claimed in claim 1, in which the tether has a density of from about 740 to 950 Kg/m3.

15. A tethered system as claimed in claim 1, in which the sensing unit has a density of from about 950 Kg/m3 to about 1020 Kg/m3.

16. A tethered system as claimed in claim 1, in which the sensing unit has a density of from about 740 to 950 Kg/m3.

17. A tethered system as claimed in claim 1, in which the tether line contains a plurality of optical fibres.

18. A tethered system as claimed in claim 17, in which at least some of the optical fibres are within a fibre optical cable.
